(19) United States
(12) Patent Application Publication
(10) Pub. No.: US 2023/0311166 A1
(43) Pub. Date: Oct. 5, 2023

(54) STRETCHING-SHAFT SCREENING DEVICE FOR SEPARATING INSECTS, IN PARTICULAR INSECT LARVAE, OR WORMS AND RESIDUAL MATERIAL, AND USE OF SUCH A STRETCHING-SHAFT SCREENING DEVICE

(71) Applicant: Bühler Insect Technology Solutions AG, Uzwil (CH)

(72) Inventors: Vincent de GELDER, Gorinchem (NL); Andreas BAUMANN, Niederteufen (CH)

(21) Appl. No.: 18/043,208

(22) PCT Filed: Aug. 20, 2021
(86) PCT No.: PCT/EP2021/025316

§ 371 Date: Feb. 27, 2023

(30) Foreign Application Priority Data
Sep. 2, 2020 (EP) 20194176.2

(51) Int. Cl. B07B 1/48; B07B 4/02

(52) U.S. Cl. CPC B07B 1/485; B07B 4/02

(57) ABSTRACT

A stretching-shaft screening device for separating insects, in particular insect larvae, or worms and residual material, is disclosed, having a screen that has a first screening portion and an adjoining second screening portion, wherein the mesh size in the first screening portion is smaller than the mesh size in the second screening portion. The invention also relates to the use of a stretching-shaft screening device for separating insects, in particular insect larvae, or worms and residual material.

The present invention relates to a stretching-shaft screening device for separating insects—in particular, insect larvae—or worms and residual material according to claim 1, and to the use thereof according to claim 13.

The invention relates to the field of obtaining nutrients, feeds, and foodstuffs from insects or worms.

In recent decades, the interest in the use of insects and worms as food and feed sources has increased—in particular, in view of the growing world population and the increasing demand for alternative and sustainable protein sources for the livestock industry. Since insects and worms are usually rich in proteins and fats, they have a relatively high nutritional or caloric value and are therefore particularly suitable for human nutrition and livestock breeding.

It is economically and ecologically desirable to grow and process insects and worms on an industrial scale in order to produce standardized nutrients that can then be used in the production of food or feed.

Insects and worms grow in containers or breeding boxes that also contain a substrate of one or more residual materials. The water content of the substrate—in particular, towards the end of the breeding period—can have a significant effect on the harvesting weight of insect larvae and worms. If the substrate is too dry, the insects and worms consume less feed, and the insect larvae and worms lose energy, resulting in a loss of harvesting weight of the insect larvae and worms. On the other hand, a substrate having a high water content towards the end of the breeding period results in a higher weight of insect larvae and worms.

However, separating insect larvae and worms from the residual material or the substrate is more difficult when the substrate is moist and sticky.

Separation by means of wet screening methods requires a large amount of water. The substrate located in the water must then be eliminated in a complicated process. In addition, wet screening impairs the marketing of the substrate, e.g., as a fertilizer, because valuable minerals are washed out.

Dry screening methods tend to clog the screen openings with the moist and sticky substrate.

Surprisingly, it was found that a dynamic screening device in the form of a stretching-shaft screening device could be suitable.

DE 1 206 372 A or EP 0 679 448 B1 already discloses stretching-shaft screening devices.

DE 2 158 128 A1 also discloses a stretching-shaft screening device in which screening is carried out with alternately stretched and unstretched screening zones connected in series.

A disadvantage of these known stretching-shaft screening devices is that they are unsuitable for adequate screening of insects—in particular, insect larvae—or worms with residual material having a high moisture content.

It is an object of the present invention to overcome at least a portion of the disadvantages known from the prior art. In particular, adequate screening of insects—in particular, insect larvae—or of worms and residual material having a high moisture content is to be ensured. An industrial application is to be possible.

These objects are achieved at least in part by the features of the independent claims. Further advantageous embodiments result from combinations with the features of the corresponding dependent claims and from the statements in the description and figures.

According to the invention, the stretching-shaft screening device for separating insects—in particular, insect larvae—or worms and residual material has a screen that has a first screening portion and an adjoining second screening portion, wherein the mesh size in the first screening portion is smaller than the mesh size in the second screening portion.

Due to the mechanical influence of the movement of the screen, i.e., the bending and unloading of the screen during the operation of the stretching-shaft screening device, the residual material adhering to the insects, insect larvae, or worms is detached from them, and any agglomerates are dissolved. In addition, the residual material is also screened, wherein the fine fractions of the residual material can be collected. In particular, the chitin of the insects and the insect larvae contained in the screened fine fractions is of interest for further utilization.

In the region of the first screening portion of the screen, the mesh size is selected such that the insects, insect larvae, or worms do not fall through the screen, but only the fine fractions of the residual material. The movement of the screen transports the insects, insect larvae, or worms to the second screening portion of the screen.

The mesh size of the second screening portion of the screen is selected such that the insects, insect larvae, or worms fall through, but not larger parts of the residual material. The larger parts of the residual material are transported further by the movement of the screen until they fall from the screen at the end thereof. The separated insects, insect larvae, or worms are subsequently sent for further processing.

The stretching-shaft screening device according to the invention allows for a high degree of separation of insects, insect larvae, or worms from the residual material. In particular, this stretching-shaft screening device has proven advantageous for the separation of live insects and live worms in all stages of development.

Preferably, the first screening portion has at least one screening mat that is advantageously arranged replaceably in the stretching-shaft screening device. This ensures a long life for the stretching-shaft screening device, because a defective screening mat can be easily replaced by a new screening mat.

Advantageously, the first screening portion has several screening mats that are, further advantageously, arranged replaceably in the stretching-shaft screening device. The first screening portion thus has a high degree of flexibility in the movement of the screen. The screening mats are replaced, for example, at the end of a certain service life or in the event of a defect. If necessary, the screening mats can also be arranged differently from one another, allowing the screening result to be easily adapted.

Experiments have shown that a first screening portion with 6 to 20 screening mats is particularly advantageous, and 8 to 15 screening mats further particularly advantageous.

Alternatively or additionally, the second screening portion has at least one screening mat that is advantageously arranged replaceably in the stretching-shaft screening device. This ensures a long life for the stretching-shaft screening device, because a defective screening mat can be easily replaced by a new screening mat.

Advantageously, the second screening portion has several screening mats that are arranged replaceably in the stretching-shaft screening device. The second screening portion thus has a high degree of flexibility in the movement of the screen. The screening mats are replaced, for example, at the end of a certain service life or in the event of a defect. If necessary, the screening mats can also be arranged differently from one another, allowing the screening result to be easily adapted.

Experiments have shown that a second screening portion with 1 to 20 screening mats is particularly advantageous, and 1 to 10 screening mats further particularly advantageous.

The mesh size of the at least one screening mat of the first screening portion is preferably 60 mm² to 110 mm², whereby a large part of the residual material falls through the first screening portion of the screen, but the insects, insect larvae, or worms remain on this first screening portion. The proportion of insects, insect larvae, or worms that fall through the meshes in this first screening portion is kept small due to this mesh size, which has an advantageous effect on the crop yield.

Preferably, the mesh size of the at least one screening mat of the second screening portion is 140 mm² to 400 mm², whereby the insects, insect larvae, or worms fall through the meshes, but coarse fractions of the residual material on the second screening portion remain until they are transported away.

The mesh size of one screening mat is preferably different from the mesh size of another screening mat in the first screening portion, whereby a variable screening takes place in the first screening portion, which has an advantageous effect on the degree of separation of the separated insects, insect larvae, or worms, and thus on further processing.

Alternatively or additionally, in the second screening portion, the mesh size of one screening mat is different from the mesh size of another screening mat, whereby a variable screening takes place in the second screening portion, which has an advantageous effect on the degree of separation of the separated insects, insect larvae, or worms, and thus on further processing.

Preferably, the meshes of a screening mat have different mesh sizes, whereby a variable screening takes place in the first screening portion, which has an additional advantageous effect on the degree of separation of the separated insects, insect larvae, or worms, and thus on further processing.

The at least one screening mat or all screening mats are, advantageously, elastic. During the operation of the stretching-shaft screening device, the screening mat is tensioned and relaxed, which changes the mesh geometry—in particular, the length-to-width ratio—thus preventing clogging of the meshes.

The screen length of the first screening portion is preferably longer than the sieve length of the second screening portion, such that the dwell time of the material to be screened in the region of the first screening portion is higher than in the second screening portion. As a result of the longer dwell time, more intensive screening takes place, such that a higher degree of separation of the separated insects, insect larvae, or worms is achieved, which has an additional advantageous effect on the further processing thereof.

Preferably, at least the screen is arranged at an incline, which further improves the transport of the insects, insect larvae, or worms on the moving screen.

An inclination of the screen with respect to the horizontal of a maximum of 25° has proven advantageous. The inclination is determined by the angle between a center line, extending through the screen in its longitudinal direction or transport direction, and the horizontal.

In this case, advantageous results were obtained—in particular, in the case of an inclination of the screen with respect to the horizontal of 5° to 23°, and further, particularly preferably, in the case of an inclination of the screen with respect to the horizontal of 10° to 15°.

Preferably, at least one retaining curtain is provided for partially retaining insects—in particular, insect larvae—or worms and the residual material, which prevents too rapid a transport of the insects on the moving screen. This increases the dwell time of the insects, insect larvae, or worms and the residual material, which ensures high-grade screening and additionally has an advantageous effect on the further processing of the insects, insect larvae, or worms.

Further preferably, several retaining curtains are provided that, in certain portions, ensure that the transported insects, insect larvae, or worms and the residual material are braked during their transport.

Preferably, the at least one retaining curtain has a retaining height corresponding to at most 0.95 times the height between the screen and a cover above the screen or to an—in relation to the installation orientation of the stretching-shaft screening device—upper end of a region located above the screen, whereby the insects, insect larvae, or worms and the residual material are sufficiently braked, but can still be transported on the moving screen.

In this context, the height is understood to mean the vertical length between a center line, extending through the screen in its longitudinal direction, and the cover over the screen of the stretching-shaft screening device. If no cover is provided above the screen, the height is defined as the vertical length between the center line, extending through the screen in its longitudinal direction, and the—in relation to the installation orientation of the stretching-shaft screening device—upper end of a region located above the screen.

The retaining curtains are oriented vertically, for example. Alternatively, all or individual retaining curtains can also be oriented perpendicular to the inclination of the screen, whereby the braking effect of the retaining curtains can be additionally influenced at least in certain regions.

Preferably, at least one separating device for separating fine fractions and/or light fractions of the residual material is provided, whereby light fine fractions or light fractions of the residual material can be easily separated. The terms, “fine fractions” and “light fractions,” refer to low-density materials. In particular, the valuable chitin can be separated easily with the at least one separation device.

Depending upon the type of residual material and the fine fractions or light fractions contained therein, an arrangement comprising more than one separating device has proven to be advantageous. In this case, the separating devices can be of different types or different functions, such that certain fine fractions or light fractions can be sorted out separately by means of these separating devices.

Advantageously, the at least one separating device comprises a suction device that sucks in fine fractions or light fractions. In this case, the suction strength can advantageously be set in such a way that only certain fine fractions or light fractions are sucked off by it.

Alternatively, the at least one separating device comprises a blowing device that blows away fine fractions or light fractions. In this case, the blowing strength can advantageously be set in such a way that only certain fine fractions or light fractions are blown away by it.

It is also conceivable for the separating device to also comprise only one fan capable of both sucking and blowing, so that the most advantageous separation can take place by means of sucking or blowing according to the composition of the residual material.

Further advantageously, the at least one separating device is arranged in front of the screen in the transport direction of the screen, whereby the corresponding fine fractions of the residual material are already separated during the feeding.

Preferably, at least one rescreening device is provided for the screening of screened fractions, whereby the loss of insects—in particular, insect larvae—or worms can be reduced.

Advantageously, the at least one rescreening device is downstream of the first screening portion, such that insects, insect larvae, or worms falling through the meshes of the first screening portion can be screened out. This at least one rescreening device advantageously has mesh sizes and/or mesh patterns that are smaller than the mesh sizes and/or mesh patterns of the first screening portion, whereby fine fractions can still fall through the meshes of the at least one rescreening device, but screened insects, insect larvae, or worms can be captured.

Alternatively or additionally, the at least one rescreening device is arranged downstream of the second screening portion such that insects, insect larvae, or worms still present in the residual material screened out from the second screening portion can still be screened out, or insects, insect larvae, or worms falling through the meshes of the second screening portion can be separated into different size classes.

In order to still be able to screen out insects, insect larvae, or worms that are still present in the residual material using said rescreening device, said at least one rescreening device advantageously has mesh sizes and/or mesh patterns that are larger than the mesh sizes and/or mesh patterns of the second screening portion, whereby residual material can still fall through the meshes of the at least one rescreening device, but insects, insect larvae, or worms that are still present in the residual material can be captured by said rescreening device.

In order to separate insects, insect larvae, or worms falling through the meshes of the second screening portion into different size classes, said at least one rescreening device advantageously has mesh sizes and/or mesh patterns that are smaller than the mesh sizes and/or mesh patterns of the second screening portion, whereby insects, insect larvae, or worms can also partially fall through the meshes of the at least one rescreening device.

Advantageously, the at least one screening mat or all the screening mats of a rescreening device can be moved elastically and by the corresponding mechanism of the stretching-shaft screening device. During the operation of the stretching-shaft screening device, the screening mat is tensioned and relaxed, which changes the mesh geometry—in particular, the length-to-width ratio—thus preventing clogging of the meshes even during rescreening.

In a further aspect, the invention relates to the use of a clamping shaft screening device for separating insects—in particular, insect larvae—or worms and residual materials according to at least one part of the above-mentioned embodiments.

Preferably, the stretching-shaft screening device is used for screening live insects—in particular, live insect larvae—or live worms, because the insects and worms are gently screened and transported in all development stages using said stretching-shaft screening device.

The invention is explained in more detail below with reference to an exemplary embodiment and a drawing. In the drawing:

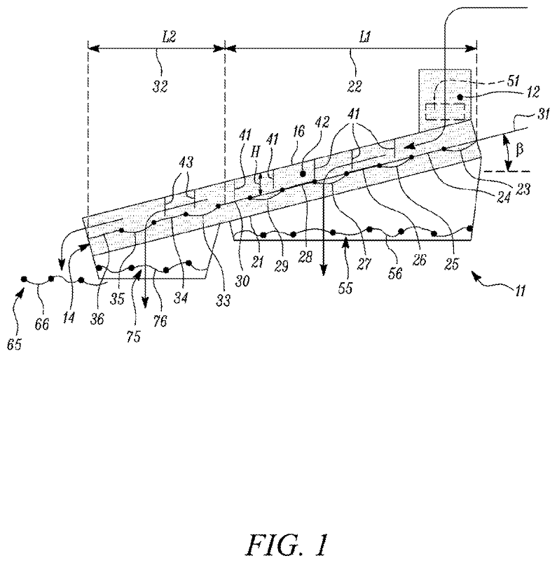

FIG. 1: shows a stretching-shaft screening device according to the invention in a schematic longitudinal section.

The stretching-shaft screening device 11 shown in FIG. 1 for separating live black soldier fly larvae (BSF larvae; Hermetia illucens) or live mealworms (e.g., Tenebrio molitor, Zophobas morio, or Alphitobius diperinus) and residual material has a screen 21 and a mechanism, not shown here, for moving the screen 21, which mechanism is known to be formed in such a stretching-shaft screening device 11. By means of this mechanism, the screen 21 is bent, stretched, and unloaded. In this case, the material located on the screen 21 is moved from a feed opening 12 to a delivery opening 14, and screening takes place at the same time.

The contents of the cultivation container, i.e., the larvae or mealworms with the residual material, are poured into a feed opening 12 of the stretching-shaft screening device. As a result of the movement of the screen 21, the material located on the screen 21 is moved from the feed opening 12 to a delivery opening 14, and screening takes place at the same time (see arrows).

The screen 21 has a first screening portion 22 having eight (8) screening mats 23 through 30. These screening mats 23 through 30 are replaceably fixed in the stretching-shaft screening device 11 so as to be interchangeable.

The mesh size of the screening mats 23 through 30 of the first screening portion 22 is 60 mm² to 110 mm². The screening mats 23 through 30 of the first screening portion 22 can all be of the same mesh size and/or mesh pattern.

In the present exemplary embodiment, the mesh size of one screening mat is different from the mesh size of another screen mat. For example, the screening mats 23, 27, and 30 have a mesh size of 3 mm×29 mm. By contrast, the mesh size of the screening mats 24 and 26 is 3.5 mm×30 mm. The screening mats 25, 28, and 29 have a mesh size of 2.5 mm×25 mm.

A screening mat 23 through 30 of the first screening portion 22 can have meshes of one mesh size or meshes of a different mesh sizes.

The screen 21 further has a second screening portion 32 having four (4) screening mats 33 through 36, wherein the second screening portion 32 is directly adjacent to the first screening portion 22. The screening mats 33 to 36 of the second screening portion 32 are replaceably fixed in the stretching-shaft screening device 11 so as to be interchangeable.

The mesh size of the screening mats 33 through 36 of the second screening portion 32 is 140 mm² to 400 mm². The screening mats 33 to 36 of the second screening portion 32 can all be of the same mesh size and/or mesh pattern.

In the present exemplary embodiment, the mesh size of one screening mat is different from the mesh size of another screen mat. For example, the screening mat 33 has a mesh size of 8 mm×30 mm. By contrast, the mesh size of the screening mat 34 is 12 mm×12 mm. The screening mat 35 has a mesh size of 15 mm×15 mm, and the screening mat 36 has a mesh size of 20 mm×20 mm.

A screening mat 33 through 36 of the second screening portion 32 can have meshes of one mesh size or meshes of different mesh sizes.

The horizontal screen length L1 of the first screening portion 22 is longer than the horizontal screen length L2 of the second screening portion 32.

In this exemplary embodiment, the screen 21 is arranged at an inclination β of 14° to the horizontal.

The screen 21 is covered by a cover 16 such that no screen material can escape from the stretching-shaft screening device 11.

In the region of the first screening portion 22, five (5) retaining curtains 41 are provided for partially retaining the insect larvae and residual material. In the present example, these retaining curtains 41 are arranged at uniform distances from one another and extend from the cover 16 vertically in the direction of the screen 21. Here, the retaining curtains 41 each have a vertical retaining height that corresponds to 0.75 times the height H of the space 42.

In the region of the second screening portion 32, two (2) retaining curtains 43 are provided for partially retaining the insect larvae and residual material. In the present example, these retaining curtains 43 are arranged in the front half—in relation to the transport direction—of the second screening portion 32. The retaining curtains 43 also extend vertically from the cover 16 in the direction of the screen 21.

The space 42 between the screen 21 (or center line 31 thereof) and the cover 16 is of a vertically-measured height H. In the present exemplary embodiment, the retaining curtains 41 each are of a vertical retaining height that corresponds to 0.7 times the height H of the space 42. In contrast, the retaining curtains 43 each are of a vertical retaining height that corresponds to 0.6 times the height H of the space 42.

In an embodiment not shown here, all retaining curtains 41 and 43 can be of the same vertical retaining height. Furthermore, the retaining curtains 41 in the first screening portion 22 and/or the retaining curtains 43 in the second screening portion 32 can also be of different vertical retaining heights.

A separating device 51, for separating fine fractions of the residual material, is provided in the region of the feed opening 12, and thus in the transport direction of the screen 21 in front of the screen 21. In this case, this separating device 51 comprises a suction device with which fine fractions—in particular, chitin—are separated before the screening. This suction device comprises a suction fan, the suction strength of which can be adjusted by means of a controller—in particular, a controller of the suction device.

Instead of or in addition to a suction device, the separating device 51 can comprise a blowing device. Such a blowing device comprises a fan, the blowing strength of which can be adjusted by means of a controller—in particular, a controller of the suction device.

The first screening portion 22 is followed by a first rescreening device 55 for the screening of screened fractions. The first rescreening device 55 has several screening mats 56—for example, seven (7) in this case. The mesh sizes and/or mesh patterns of the screening mats 56 are smaller than the mesh sizes and/or mesh patterns of at least a part of the screening mats 23 through 30 of the first screening portion 22, whereby fine fractions can still fall through the meshes of the first rescreening device 55, but screened insects, insect larvae, or worms are collected.

The second screening portion 32 is followed by a second rescreening device 65 for the screening of screened fractions—specifically, downstream of the delivery opening 14. The second rescreening device 65 has several screening mats 66—for example, three (3) in this case. The mesh sizes and/or mesh patterns are larger than the mesh sizes and/or mesh patterns of the screening mats 33 through 36 of the second screening portion 32, whereby residual material can still fall through the meshes of the second rescreening device 65, but insects, insect larvae, or worms located in the residual material are collected by said rescreening device 65.

There is also a third rescreening device 75 for separating the screened fractions of insects, insect larvae, or worms into different size classes downstream of the second screening portion 32. The third rescreening device 75 has several screening mats 66—for example, four (4) in this case. The mesh sizes and/or mesh patterns are smaller than the mesh sizes and/or mesh patterns of at least a part of the screening mats 33 through 36 of the second screening portion 32, whereby part of the insects, insect larvae, or worms still fall through the meshes of the third rescreening device 75, and the other part of the insects, insect larvae, or worms is separated therefrom.

### LIST OF REFERENCE SIGNS

11 stretching-shaft screening device

12 feed opening

14 delivery opening

16 cover

21 screen

22 1st screening portion

23 screening mat

24 screening mat

25 screening mat

26 screening mat

27 screening mat

28 screening mat

29 screening mat

30 screening mat

31 center line of 21

32 2nd screening portion

33 screening mat

34 screening mat

35 screening mat

36 screening mat

41 retaining curtain at 22

42 space

43 retaining curtain at 32

51 separating device

55 1st rescreening device

56 screening mat of 55

65 2nd rescreening device

66 screening mat of 65

75 3rd rescreening device

76 screening mat of 75

L1 horizontal screen length of 22

L2 horizontal screen length of 32

H vertical height of 41 or 43

B inclination of 21

1. A stretching-shaft screening device for separating insects—in particular, insect larvae—or worms and residual material, having a screen that has a first screening portion and an adjoining second screening portion, wherein the mesh size in the first screening portion is smaller than the mesh size in the second screening portion.

2. The stretching-shaft screening device according to claim 1, wherein the first screening portion has at least one screening mat, advantageously, several screening mats, further advantageously, 6 to 20 screening mats, and, particularly advantageously, 8 to 15 screening mats, and/or
the second screening portion has at least one screening mat, advantageously, several screening mats, further advantageously, 1 to 20 screening mats, and, particularly advantageously, 1 to 10 screening mats.

3. The stretching-shaft screening device according to claim 2, wherein the mesh size of the at least one screening mat of the first screening portion is 60 mm² to 110 mm².

4. The stretching-shaft screening device according to claim 2, wherein the mesh size of the at least one screen mat of the second screening portion is 140 mm² to 400 mm².

5. The stretching-shaft screening device according to claim 2, wherein, in the first screening portion, the mesh size of one screening mat is different from the mesh size of another screening mat, and/or,
in the second screening portion, the mesh size of one screen mat is different from the mesh size of another screen mat.

6. The stretching-shaft screening device according to claim 2, wherein the meshes of a screening mat have different mesh sizes.

7. The stretching-shaft screening device according to claim 1, wherein the screen length of the first screening portion is longer than the screen length of the second screening portion.

8. The stretching-shaft screening device according to claim 1, wherein at least the screen is arranged at an incline, wherein the inclination with respect to the horizontal is advantageously at most 25°, preferably 5° to 23°, and particularly preferably 10° to 15°.

9. The stretching-shaft screening device according to claim 1, wherein at least one retaining curtain is provided for partially retaining insects—in particular, insect larvae—or worms, wherein several retaining curtains are preferably provided.

10. The stretching-shaft screening device according to claim 9, wherein the at least one retaining curtain has a retaining height that corresponds at most to 0.95 times the height between the screen and a cover above the screen or an—in relation to the installation orientation of the stretching-shaft screening device—upper end of a region located above the screen.

11. The stretching-shaft screening device according to claim 1, wherein at least one separating device is provided for separating fine fractions and/or light fractions of the residual material, wherein the at least one separating device advantageously comprises a suction device or blowing device, wherein,
further advantageously, the at least one separating device is arranged upstream of the screen in the transport direction of the screen.

12. The stretching-shaft screening device according to claim 1, wherein at least one rescreening device is provided for screening out screened fractions, wherein
the at least one rescreening device is advantageously connected downstream of the first screening portion and/or
downstream of the second screening portion.

13. A use of a stretching-shaft screening device—in particular, a stretching-shaft screening device according to claim 1—for separating insects—in particular, insect larvae—or worms and residual material.

14. The use according to claim 13, for screening live insects—in particular, live insect larvae—or live worms.
